(19) United States
(12) Patent Application Publication
(10) Pub. No.: US 2005/0016489 A1
(43) Pub. Date: Jan. 27, 2005

(54) Method of producing coated engine components

(76) Inventors: Mark Thomas Endicott, Mooresville, NC (US); Randall John Wischhusen, Chesterland, OH (US)

Correspondence Address: MARK T. ENDICOTT, 333-A ROLLING HILLS ROAD, MOORESVILLE, NC, 28117, US

(21) Appl. No.: 10/625,286

(22) Filed: Jul. 23, 2003

(51) Int. Cl. F02F 1/18

(52) U.S. Cl. 123/193.2; 427/455; 92/223

(57) ABSTRACT

To improve engine performance and reduce wear and friction, a porous coating is applied to piston skirts and cylinder bores via a thermal spray process. The porous nature of the coating allows for oil to be held on the surfaces enhancing lubrication.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF INVENTION

Pistons, as used in a typical internal combustion engine, transmit the forces of expanding combustion gases to the connecting rods. Pistons are typically made of aluminum or iron alloys and are cylindrical, hollow parts that fit closely within the engine cylinders. Since the hot gases impinge on the top of the piston, the piston head and rings experience intense heat and friction. Below the rings, the piston skirt, or body of the piston that has a bearing area with the cylinder wall, also experiences a substantial amount of heat and friction. The purpose of this invention is to provide a surface coating onto the piston skirt and to the cylinder bore to reduce friction and thus improve performance and durability of the engine. Specifically, this invention teaches a method to apply, via thermal spray, a porous metal to the surface of the piston skirt and cylinder bore. This type of coating not only provides a wear resistant surface layer but also allows oil to be carried on the surface within the porosity.

There are many technologies used commercially to pistons. Understandably, the majority of these efforts have focused on the piston rings due to the harsh environment they experience. Coatings applied to the rings are typically very hard and heat resistant and can be applied by various methods including thermal spray. Thermal spray may also be used to provide coatings on piston skirts, however these are typically polymeric or a dry lubricant, and not a metallic coating. This invention, therefore, combines a number of previously separate technologies to provide for a substantially improved piston skirt coating. That is, the use of thermal spray of a porous, metallic coating on piston skirts is a new, novel invention that provides improved performance and durability over the prior art technologies.

Many engine blocks are manufactured from aluminum-silicon alloys and the cylinder bores are typically fitted with sleeves or liners of cast iron to protect the block from the intense heat of the combustion chamber. For special vehicle applications, these liners can be replaced. Alternatives include electroplated hard coatings, the use of acids to etch away the aluminum matrix leaving hard silicon particles on the surface and the use of alternative liners. In addition, to potentially improve performance and reduce manufacturing costs, thermally sprayed coatings have occasionally replaced liners. These coatings tend to be either hard, dense coatings, or coatings which mimic the ferrous sleeve they replace. The application of a porous metallic coating with oil-carrying ability is a novel invention that successfully replaces iron liners and improves engine performance.

One commercially popular method to enhance the lubricity of the surface of the piston skirt is by coating with a dry film lubricant. This lubricant, typically consisting of a molybdenum disulfide, graphite, a polymer, or some combination of these can be applied a number of ways including spraying. Another method, that of a transfer pad process is described in U.S. Pat. No. 5,266,142 in which the lubricants are diluted with solvents so that a wet film is applied. While the dry lubrication of piston skirts is commercially widespread, these coatings have a limited ability to withstand the harsh engine environment.

There are some examples of metal-based coatings used on piston skirts, although each is fundamentally different from this invention. U.S. Pat. No. 3,935,797 describes a piston onto which an adherent coating has been applied to the skirt by the application of an iron-carbon powder. The resulting coating, and the optional manganese phosphate addition, are said to impart wear and seizure resistance to the aluminum piston alloy. Another method is described in U.S. Pat. No. 4,018,949, in which an aqueous solution of potassium stannate is applied to the aluminum piston skirt that effectively adherently deposits an ultra-thin tin coating. U.S. Pat. No. 5,884,600 teaches the use of a hard anodizing technique on the piston skirt in which a composite polymer coating is then applied. This is said to enhance the wear and scuff resistance of the piston.

The prior art also teaches thermal spray techniques to apply coatings to various engine parts. Although specifically used on suspension damper rods and not the piston skirt, U.S. Pat. No. 6,189,663 is instructive in that it teaches the application of a thermal or kinetic spray coating of metal or ceramic. It is noteworthy that while the invention teaches that the spray coatings are porous, this property is not desired and the porous coating should be sealed for corrosion protection. Similarly, U.S. Pat. No. 5,713,129 teaches the high velocity oxy-fuel (HVOF) method of thermal spray to provide for coated piston rings to improve wear resistance. U.S. Pat. No. 6,562,480 also teaches the HVOF coating of piston rings as well as cylinder liners, although the coating applied is a hard, dense nickel alloy. Another thermal spray method, plasma flame spray is described in U.S. Pat. No. 3,976,809 to deposit multiple metal and ceramic layers on the combustion surface of a piston. These layers of nickel aluminum and zirconium oxide provide a thermal barrier to the aluminum piston so that higher operating temperatures can be achieved. In addition to the references cited above, there is a commercial technology in which metals are used to face the top piston ring to enhance compression sealing to improve engine performance. This method involves a mechanical or thermally sprayed on layer of molybdenum or chromium on the outer, or wear surface of the ring. It is recognized this layer on the ring can enhance the life of the piston due to the slightly porous nature of the coating, which is advantageous for the ability to carry oil. However, it is clear that this technology has been only used on piston rings and there appear to be no examples of its use on piston skirts. Thus it is clear that while thermal spray has been utilized for engine components, the combination of utilizing this technique to spray porous metallic coatings on piston skirts is a new and useful invention.

There is also some prior art teaching the thermal spray coating of cylinder bores. In a presentation given at the Cold Spray Workshop (July 1999 at Sandia National Laboratories, Albuquerque, New Mexico), a cooperative research program between Sandia and General Motors Corporation is described in which the development of the HVOF spraying of aluminum engine blocks is described. This development focused exclusively on the cylinder bores and was primarily to replace cast iron cylinder liners with a sprayed-on iron coating. The cylinder liner protects the soft aluminum engine block from wear. In a similar manner, Ford Motor Company teamed with Sulzer Metco Inc. to develop a plasma-sprayed bore to provide a low friction interface with the piston. They settled on a stainless steel and a solid-film lubricant, and a material that contains iron and iron oxides. In another example, U.S. Pat. No. 5,080,056 teaches the thermal spraying of aluminum cylinder bores and piston skirts with an aluminum-bronze alloy. While the application of a metallic coating to the piston skirt is similar to the current invention, U.S. Pat. No. 5,080,056 provides for a dense pore-free structural coating to improve wear and scuff resistance. Other examples of thermally applied dense coatings to cylinder bores include U.S. Pat. No. 6,080,360 in which an aluminum-silicon alloy is applied and U.S. Pat. No. 6,572,931 in which a ferrous coating is applied. Thus, in each of these examples, while thermal spray techniques were used to coat cylinder bores; the application of a porous metallic coating was not practiced. It is the porous nature of the coating of this invention that distinguishes it from the prior art and enhances the ability of the bores to carry oil, reducing friction with the pistons.

To summarize, the prior art for piston skirt coatings involve dry lubricants, polymers or hard, non-porous surfaces. Coatings on cylinder bores have been developed to replace the heavy iron-based sleeve that is used to improve aluminum engine block wear. While thermal spray processes have been utilized, primarily on the cylinder bores and piston rings, these again are used to apply hard, wear resistant coatings. Finally, the benefits of a porous metallic surface have been recognized, but only as applied to piston rings. It is clear therefore; that the application of a metallic, porous and thus oil-bearing, surface to piston skirts and cylinder bores via a thermal spray process is a novel and valuable invention.

### BRIEF SUMMARY OF THE INVENTION

The present invention provides for a process in which engine components are coated with a porous metallic layer applied via thermal spray. In the embodiments of this invention, the piston skirt or engine block cylinder bores are coated via a thermal spray process with molybdenum metal or a molybdenum alloy. In other embodiments, the coating consists of a layer of brass or bronze. In yet other embodiments, the coating consists of a hard metal, ceramic or cermet. Optionally, these porous coatings can further be sealed or impregnated with an additional lubrication agent. These coatings provide wear resistance at the interface of the piston and cylinder bore and reduction friction due to the increased oil-carrying capacity of the surfaces.

### BRIEF DESCRIPTION OF THE SEVERAL VIEWS OF THE DRAWING

Not Applicable

### DETAILED DESCRIPTION OF THE INVENTION

According to the present invention, piston skirts or cylinder bores are grit blasted in preparation for thermal spray surface treatment. A coating is then applied via a thermal spray technique, such as plasma spray or HVOF. The coating can be a refractory metal, although an alloy, a cermet, carbide, ceramic or other like material can be used. In one embodiment, the application of the coating is such that it is bonded well with the retainer substrate and the surface finish is rough and somewhat porous. In another embodiment, the porous coating is further impregnated with an additional lubrication agent. It is the combination of the coating material's rough surface texture and the porous nature of the coating that provides for the improved wear resistance over prior art coatings by providing for both wear resistance and the ability for the surface to carry and retain oil.

### EXAMPLE 1

Step 1: The skirt area of an aluminum alloy piston was abrasively blasted to create a surface roughness of 200+/−25 microinches. Surfaces other than the skirt area were masked off with thermal tape.

Step 2: A thermal plasma torch was used run on an N₂H₂ gas mixture at 28.4 kW using a 5.5-inch spray distance and a powder flow rate of 5 pounds per hour. In this example, molybdenum alloy, −170/+325 mesh size was the coating material.

Step 3: Excess powder was brushed off the piston and the masking removed.

### EXAMPLE 2

Step 1: The skirt area of an aluminum alloy piston was abrasively blasted to create a surface roughness of 200+/−25 microinches. Surfaces other than the skirt area were masked off with thermal tape.

Step 2: A thermal spray wire process was used in which wire was passed through an oxy-acetylene flame and propelled at the piston by compressed air. A 4-inch spray distance and a spray rate of 4 pounds per hour were used with a molybdenum metal wire, 0.125-inch diameter.

Step 3: The masking was removed from the skirt.

### EXAMPLE 3

Step 1: The cylinder bores of two aluminum alloy engine blocks, one with and one without a cast iron cylinder liner, were abrasively blasted to create a surface roughness of 200+/−25 microinches. Surfaces other than the bore area were masked off with thermal tape.

Step 2: A miniature thermal plasma torch was used run on an ArH₂ gas mixture at 16 kW using a 0.75-inch spray distance and a powder flow rate of 4 pounds per hour. In this example, a molybdenum alloy, in the form of −170/+325 mesh size powder was the coating material.

Both engines were dynamometer tested for maximum horsepower and were found to produce 3%-7% more horsepower than before the bore was coated. In addition, wear of the cylinder bore was reduced particularly in the aluminum block without the cast iron cylinder liner.

It is recognized that while the present invention has been described with reference to preferred embodiments, various details of the invention can be changed without departing from the scope of the invention. Furthermore, no limitations are intended to the details of the process shown, other than as described in the claims below.

1. A method for treating piston skirts by the application of a porous coating via a thermal spray technique chosen from the group consisting essentially of oxy-fuel thermal spray, oxy-fuel wire spray, plasma spray, high velocity oxy-fuel (HVOF), plasma and twin-wire arc spray.

2. The method of claim 1 wherein said porous coating consists primarily of a metal, metal alloy, a cermet, a ceramic material, or a combination of said materials.

3. The method of claim 1 wherein said porous coating consists primarily of the metal molybdenum or of a molybdenum alloy.

4. The method of claim 1 wherein said porous coating is chosen from the group consisting essentially of bronze and brass alloys.

5. The method of claim 1 wherein said porous coating is chosen from the group consisting essentially of titanium carbide, chromium carbide, tungsten carbide and boron carbide.

6. The method of claim 1 wherein said porous coating is further impregnated with a lubrication agent.

7. A method for treating engine block cylinder bores by the application of a porous coating via a thermal spray technique chosen from the group consisting essentially of high velocity oxy-fuel (HVOF), plasma, twin-wire arc, detonation gun, flame spray and cold spray.

8. The method of claim 7 wherein said porous coating consists primarily of a metal, metal alloy, a cermet, a ceramic material, or a combination of said materials.

9. The method of claim 7 wherein said porous coating consists primarily of the metal molybdenum or of a molybdenum alloy.

10. The method of claim 7 wherein said porous coating is chosen from the group consisting essentially of bronze and brass alloys.

11. The method of claim 7 wherein said porous coating is chosen from the group consisting essentially of titanium carbide, chromium carbide, tungsten carbide and boron carbide.

12. The method of claim 7 wherein said coating is applied such that the thickness is greater than the desired final thickness and said coated cylinder bores are further machined to the desired finished dimension.

13. The method of claim 7 wherein said porous coating is further impregnated with a lubrication agent.

14. The method of claim 7 wherein said engine block is fabricated from an aluminum alloy.

15. The method of claim 7 wherein said cylinder bores are comprised of a ferrous alloy liner contained within an aluminum alloy engine block.

16. Piston, in which the skirt of said piston is coated via a thermal spray technique with a layer of a porous coating, in which said coating consists primarily of a metal, metal alloy, a cermet, a ceramic material, or a combination of said materials.

17. Piston of claim 16 wherein said porous coating consists primarily of the metal molybdenum or of a molybdenum alloy.

18. Piston of claim 16 wherein said porous coating is chosen from the group consisting essentially of bronze and brass alloys.

19. Piston of claim 16 wherein said porous coating is chosen from the group consisting essentially of titanium carbide, chromium carbide, tungsten carbide and boron carbide.

20. Piston of claim 16 wherein said porous coating is further impregnated with a lubrication agent.

21. Piston of claim 16 wherein said thermal spray technique is chosen from the group consisting essentially of oxy-fuel thermal spray, oxy-fuel wire spray, plasma spray, high velocity oxy-fuel (HVOF), plasma and twin-wire arc spray.

22. An aluminum alloy engine block containing a porous, thermally sprayed coating of a molybdenum alloy applied to the cylinder bores.

23. The aluminum alloy engine block of claim 22 wherein said cylinder bores are lined with a ferrous sleeve, onto which said coating is applied.

24. The aluminum alloy engine block of claim 22 wherein said porous coating consists primarily of a metal, metal alloy, a cermet, a ceramic material, or a combination of said materials.

25. The aluminum alloy engine block of claim 22 wherein said porous coating consists primarily of the metal molybdenum or of a molybdenum alloy.

26. The aluminum alloy engine block of claim 22 wherein said porous coating is chosen from the group consisting essentially of bronze and brass alloys.

27. The aluminum alloy engine block of claim 22 wherein said porous coating is chosen from the group consisting essentially of titanium carbide, chromium carbide, tungsten carbide and boron carbide.

28. The aluminum alloy engine block of claim 22 wherein said porous coating is applied such that the thickness is greater than the desired final thickness and said coated cylinder bores are further machined to the desired finished dimension.

29. The aluminum alloy engine block of claim 22 wherein said porous coating is further impregnated with a lubrication agent.

30. A ferrous alloy engine block containing a porous, thermally sprayed coating of a molybdenum alloy applied to the cylinder bores.
